(19) United States
(12) Patent Application Publication
(10) Pub. No.: US 2009/0050049 A1
(43) Pub. Date: Feb. 26, 2009

(54) TIME-TEMPERATURE INDICATORS

(76) Inventors: Vincent Craig, Macquarie (AU); Timothy John Senden, Aranda (AU); Christian Kugge, Victoria (AU)

Correspondence Address: SNELL & WILMER LLP (OC), 600 ANTON BOULEVARD, SUITE 1400, COSTA MESA, CA, 92626, US

(21) Appl. No.: 11/996,497

(22) PCT Filed: Jul. 27, 2006
(86) PCT No.: PCT/AU06/01058

§ 371 Date: Oct. 6, 2008

(30) Foreign Application Priority Data
Jul. 27, 2005 (AU) 2005904010

(51) Int. Cl. G01K 1/02; G01K 11/06

(52) U.S. Cl. 116/217; 374/160; 374/E11.006; 374/E01.002

(57) ABSTRACT

A visual thermal history indicator comprising a pattern produced from at least two waxes wherein one wax has a melting point that differs from the other wax, or where the waxes have the same melting point but different melt flow behaviour, and wherein the pattern is adapted so that when the lower melting point wax melts or the wax with greater melt flow behaviour flows, the visual appearance of the pattern changes, and wherein when the second and subsequent higher melting waxes melt, or when the lower melt flow behaviour waxes flow, the visual appearance of the pattern changes as each wax melts or flows.

### FIELD OF THE INVENTION

This invention relates to temperature indicators that may be applied directly or indirectly to packaging for perishable or heat sensitive products by deposition. The temperature indicators are formed from wax based inks and may also be applied directly or indirectly to products by deposition to provide information about the thermal history of the products.

### BACKGROUND OF THE INVENTION

It is desirable to be able to provide an indication whether a product has been exposed to an undesirable time-temperature history. This applies to perishables such as foods and pharmaceuticals. These products generally have limited useful life spans that may be significantly shortened by exposure to relatively high temperatures for a specific time period during storage, distribution, or use.

This also applies to when a predetermined time-temperature history may be required during processing or use of the product. It also pertains to certain products such as canned goods and biomedical materials which may be required to be held at certain temperatures for specific time periods to, for example, guarantee sterilisation, or to maintain efficiency.

The rate of degradation, or other change in a product, at a given temperature is typically product dependent. It would therefore be desirable to provide indicators for use with various products so that the indicators supply a visual indication of cumulative thermal exposure of a product and also supply a visual indication of the extent of thermal exposure.

U.S. Pat. No. 6,564,742, assigned to Hewlett-Packard Development Company, describes a critical temperature warning apparatus and method to monitor the thermal history of a product such as a memory card. The apparatus comprises a critical temperature indicator, which is externally attached to a product to be monitored. The indicator reveals whether the product has experienced a critical temperature. The critical temperature indicator may comprise a patterned array of wax, the wax having a melting point equal to the critical temperature. When the pattern of wax has been destroyed leaving a molten wax residue, this indicates that the product has experienced a critical temperature. The wax-based substance is arranged in a pattern which is externally attached to the memory device. The pattern of wax-based substance is arranged in a spaced apart pattern, such that successive deposits of the wax-based substance are separated by empty spaces and wherein at the predetermined temperature, the wax-based substance merges into the empty spaces between the successive deposits of the wax-based substance. A limitation of the indicators of the invention of this citation is that only one critical temperature may be monitored. Accordingly, such an indicator does not provide further information of the thermal history of the product to which the indicator is attached other than whether it has been or has not been exposed to the critical temperature.

U.S. Pat. No. 4,753,188 (Schmoegner) describes a heat history indicator which comprises a coloured solvent system, such as an oil-soluble dye within a fatty acid or wax, together with a particulate pigment. The pigment colour is dominant below the activation temperature. When heated above the activation temperate, the wax melts and wets the pigment particles thereby masking the colour of the particulate pigment.

In a more complicated arrangement, the composition can provide a temperate history by using mixtures of solvents having discrete melting points. The same dye is used in each solvent and the temperature history is indicated by the intensity of the colour of the indicator.

U.S. Pat. No. 5,057,434 (Prusik et al) describes a combined cumulative time-temperature indicator and threshold indicator. The two indicators may be arranged in separate (stacked) layers or admixed together and operate in an additive manner to provide a single visual indication.

The threshold indicator can be a layer of a heat meltable material (wax or other material) containing a dye. The layer becomes mobile above the melting point of the material and leads to colour development by diffusing into an observed layer. The cumulative or integrating indicator contains a dye which develops a colour change as a result of cumulative time-temperature exposure such as a diacetylene material. The colour change of the two types of indicators provides a single visual indication.

It would be desirable to have a temperature indicator that could provide a visual indication of the thermal history of a product whether the product is exposed to temperature above or below the critical temperature, or temperature range. For cost control reasons the indicator should not require a complicated arrangement and ideally could be printed directly onto a substrate and in a single pass, without over printing.

### SUMMARY OF THE INVENTION

In an embodiment of the invention there is provided a visual thermal history indicator comprising a pattern produced from at least two waxes wherein one wax has a melting point that differs from the other wax, or where the waxes have the same melting point but different melt flow behaviour, and wherein the pattern is adapted so that when the lower melting point wax melts or the wax with greater melt flow behaviour flows, the visual appearance of the pattern changes, and wherein when the second and subsequent higher melting waxes melt, or when the lower melt flow behaviour waxes flow, the visual appearance of the pattern changes as each wax melts or flows.

Preferably the at least two waxes have different visual appearances or are included in compositions producing the pattern which have different visual appearances.

Preferably one wax is not located above the other wax or in different layers. Preferably the waxes are located within a common layer. Preferably a portion of one wax may be adjacent to or about a portion of the other wax.

Preferably the pattern comprises an arrangement of the at least two waxes on a common substrate.

Preferably the waxes can be deposited by printing processes such as non impact printing.

Preferably the waxes can be applied to a substrate in a single pass of a printing head.

### BRIEF DESCRIPTION OF THE FIGURES

FIG. 1. depicts a visual thermal history indicator of the invention comprising two different coloured waxes on a glass support. The depicted indicator has not been exposed to a temperature above its activation temperature.

FIG. 2. depicts the visual thermal history indicator of FIG. 1 after heating above the activation temperature.

FIG. 3. depicts a visual thermal history indicator of the invention in the form of printed barcode. The depicted indicator has not been exposed to a temperature above its activation temperature.

FIG. 4. depicts the visual thermal history indicator of FIG. 3 after heating above the activation temperature.

FIG. 5. depicts a visual thermal history indicator of the invention in the form of a colour photograph (shown in greyscale). The depicted indicator has not been exposed to a temperature above its activation temperature.

FIG. 6. depicts the visual thermal history indicator of FIG. 5 after heating above the activation temperature.

FIG. 7. depicts a visual thermal history indicator of the invention in the form of a dot pattern printed on a Mylar sheet. The depicted indicator has not been exposed to a temperature above its activation temperature.

FIG. 8. depicts the visual thermal history indicator of FIG. 7 after heating above the activation temperature.

FIG. 9. depicts a visual thermal history indicator of the invention in the form of the word safe repeated printed on a Mylar sheet. The depicted indicator has not been exposed to a temperature above its activation temperature.

FIG. 10. depicts the visual thermal history indicator of FIG. 9 after heating above the activation temperature.

FIG. 11. depicts a visual thermal history indicator of the invention printed on the reverse side of paper. The depicted indicator has not been exposed to a temperature above its activation temperature.

FIG. 12. depicts the visual thermal history indicator of FIG. 11 after heating above the activation temperature viewed from the same side as in FIG. 11.

### DETAILED DESCRIPTION OF THE INVENTION

In this invention the visual appearance and changes in visual appearance can include colour changes, the appearance or disappearance of images, symbols, numbers or words, or the change in appearance of images, symbols, numbers or words, or combinations of these.

In this invention wax includes low melting point organic compounds of high molecular weight or mixtures of such compounds. Waxes are generally similar in composition to fats and oils but typically not contain glycerides. Waxes may be hydrocarbons, esters of fatty acids and alcohols. Waxes include animal waxes such as beeswax, lanolin, shellac wax, Chinese insect wax; vegetable waxes such as carnauba, candelilla, bay-berry, sugar cane; mineral waxes such as fossil or earth waxes (ozocerite, ceresin, montan and others) and petroleum waxes (paraffin, micro-crystalline) (slack or scale wax); synthetic waxes such as ethylenic polymers and polyol ether-esters (“Carboxwax”, sorbitol); chlorinated naphthalenes (Halowax) and hydrocarbon type waxes (Fischer-Tropsch waxes).

The waxes or compositions containing each wax forming the produced pattern should be selected so to have a melting point which corresponds to temperatures for which it is desirable to monitor and determine whether the indicator has been allowed to heat up to those temperatures.

It may be advantageous if the melting point waxes or overall compositions containing each wax and forming produced pattern differ from each other by at least 1° C., 2° C., 3° C., preferably at least 5° C. In some cases the temperature difference may 10° C.

In this invention deposition means any known or future process by which an ink or other surface coating preparation is applied to a substrate. Deposition includes processes of non-impact printing associated with inkjet technology applications. Deposition includes (but is not limited to) drop on demand (DOD), continuous inkstream (CIJ), shear mode actuation and shaped piezo silicon incorporating MEMS technology and associated application techniques. It also includes impact-printing processes such as gravure, flexographic, screen printing, letterpress and offset lithography. It also includes the application of specific formulations by means of brush, spray (conventional, automatic, hot spray), electrostatic applications (automatic and manual), dip applications, vacuum impregnation, flow and curtain coating, tumbling and barrelling, roller, coil and powder coating methods.

The pattern can be produced using several inks of different colours, each with a different activation temperature or melting point. The activation temperature may be the melting point of a wax based ink or it may be the temperature at which the melt flow characteristics of a wax based ink change.

An example of a pattern is a series of vertical stripes. For example, the stripes could consist of printing ink based lines of blue (activation temp 40° C.), yellow (activation temp 45° C.) red, (activation temp 50° C.), and colourless wax (activation temp 55° C.). This temperature indicator device is able to indicate a range of thermal histories of temperatures between 40° C. and 55° C. with a resolution of 5° C. If the temperature had reached 52° C. then the blue and yellow and red stripes would be blurred and the colours green (blue and yellow) and orange (red and yellow) would be apparent. The colourless wax would remain distinct indicating that a temperature of 50° C. had not been reached. The red and white would not mix to form pink because the colourless wax remained solid.

As a further example, a range of inks of different colours can be employed to provide information on the time over which a temperature had been exceeded. In this application, the inks are prepared so that they have the same melting point but different diffusion or melt flow properties. For example, the melting point may be selected to be 40° C., but the time required for a line to blur at 50° C. may differ from 1 hour for blue to 4 hours for yellow, 6 hours for red and 20 hours for colourless wax. In this case, the wax based inks, although having the same melting point, have successively lower melt flow behaviour. In this example, the time above the melting point temperature could be estimated from the blurred lines on the temperature indicator. This device works well in correlation with the temperature range indicator as the activation times are also temperature dependent. For example, blue may activate after 4 hours at 50° C. but after only 1 hour at 55° C. To achieve the necessary range of melt flow behaviour, a range of wax, wax-like or polymer additives may be required.

In some instances it may be desirable to have a temperature indicator on a product prepared in a manner such that it is not obvious that an indicator is present and/or it is not obvious when an excess temperature is being indicated. This may occur when a distributor requires such information but would prefer not to have the consumer know the same information. This is possible using multi-colour indicators. For example, in a simple form, an indicator could consist of a blue square that has many small round yellow dots printed within it. If these dots are sufficiently small this will look like a green square to the unaided eye at normal observation distances. However, with the aid of a microscope or magnifying glass, the yellow dots will be visible. Once this device has been “activated” by exposure to a temperature above the activation temperature of the inks for a sufficient time, there will be no obvious visible change in the appearance of the square to the naked eye. It will still appear as a green square. However, under microscopic examination the yellow dots will have disappeared, indicating activation. Such a device could be incorporated into the usual product packaging. Indeed, a range of indicators for different temperatures could be incorporated in different parts of the packaging such that it is not noticeable to the uninformed observer.

On some products it is desirable to have an indicator appear only after an excess temperature environment has been experienced. An example of such a product may be a pharmaceutical that is temperature sensitive. In this case, a warning could appear on the label when the drug has been damaged by excess temperatures. The indicator on the reverse side of a porous material, such as paper, is unseen until activation. Once activated, the image “appears”. This is applicable for a single colour indicator, but more complex indicators can use multiple colours. Colours such as blue could be used to indicate that the product has experienced an increased temperature but is still able to be taken. Orange could indicate that a sufficiently high temperature has been reached that the product may have a reduced shelf life, and red could be used to indicate the product has now been damaged by excess heat. Black (and perhaps a skull and cross bones) could indicate that the product has experienced a temperature that renders the contents dangerous. Alternatively, a colour image could appear upon activation.

The pattern of the indicator can vary from single arrangements to the very complex. Examples of simple patterns include an array of dots, squares, circles, dashes or other geometric patterns. More complex systems such as cross hatching and letters or words could also be used. By the appropriate selection of inks and substrates it is possible to have latest images appear or obscure existing patterns.

It is possible to build up very complex indicators using the invention described above in a single printed pattern such that a large range of information on the time temperature history of the package can be obtained. These complex images could be high quality print reproductions of digital photographs. Thus, the use of a range of colours will be an important marketing advantage in addition to the technical advantages described above.

Commercially available wax based inks can be modified to have different activation temperatures and can be used to produce the indicator of the invention. This allows the range and resolution of an indicator to be modified to suit a wide range of applications. Complex multi-colour images can be employed, for example, an image of a digital photograph.

Wax based inks suitable for the present invention are generally commercially available or can be adapted from commercial materials. The inks are prepared by typically combining the wax, pigment, solvents and additives. The formulation of such inks is well known and disclosed in U.S. Pat. Nos. 5,514,209 and 5,863,319 (Markem), the contents of which are incorporated by cross-reference.

As described in U.S. Pat. No. 5,514,209, wax based inks suitable for use in inkjet printers can include a glycerol ester of a hydrogenated rosin which contributes to the overall adhesion and cohesive properties of the ink. Typically, the rosin has a softening point not less than 60° C., an acid number less than 10 and a molecular weight of 500 to 50,000. The rosin may be Foral 85 available from Hercules Incorporated. The rosin may be present in an amount of 15% to 75% by weight, preferably 25% to 55% by weight, and preferably 30% to 45% by weight of the ink composition.

The wax based ink may also include a microcrystalline wax, preferably a wax which remains flexible at low temperatures and has a congealing point of from 55° C. to 76° C. A preferred microcrystalline wax is Okerin 103 available from Astor Wax Corp., Doraville, Ga. The microcrystalline wax may be present in an amount 15% to 70% by weight, preferably 25% to 65% by weight, preferably 35% to 60% by weight of the ink composition.

The wax based ink composition may also include a polyethylene wax which may increase hardness, improve abrasion resistance, decrease tack, increase offset resistance, and add flexibility. The polyethylene wax may be a homopolymer polyethylene with low density and a low average molecular weight. Such a wax can have a melting point of 90° C.-110° C., a density of 0.85 g/cm³ to 0.95 g/cm³ and an average molecular weight of about 2,000 to 4,500, preferably 2,500-3,500. The polyethylene wax may be present in an amount of 10% to 60% by weight, preferably 15% to 40% by weight, most preferably 15% to 30% by weight of the ink composition. An example polyethylene wax is Luwax AL3 available from BASF Aktiengesellschaft in Germany.

The wax based ink composition can also include antioxidants to inhibit thermally induced oxidation. Suitable antioxidants include those conventionally used in the art, for example dibutyl hydroxy toluene compounds and the like. An antioxidant may be present in the amount of 0.1% to 5.0% by weight, preferably 0.5% to 3.0% by weight of the ink composition.

Suitable colouring agents, present in amount of at least 0.1% to 9.0% by weight, preferably 0.5% to 3.0% by weight of the ink composition include pigments and dyes. Any dye or pigment may be chosen provided it is capable of being dispersed in the ink composition and is compatible with the other ink components. Preferably any pigment particles should have a diameter of less than 1 micron. The dyes can include Nitrofast Blue 2B (C.I. Solvent Blue 104), Morplus Magenta 36 (C.I. Solvent Red 172), Oracet Yellow GHS, and, for black ink, combinations thereof.

The wax based ink compositions can be prepared by combining together all the ink ingredients except for the colouring agent and glycerol ester of the hydrogenated rosin, heating the mixture to its melting point, and slowly stirring until the mixture is homogeneous. The glycerol ester of the hydrogenated rosin is then added to the molten mixture. The colouring agent is subsequently added to this mixture containing the glycerol ester of the hydrogenated rosin while stirring until homogeneously dispersed. The molten mixture is then filtered to remove particles larger than 1 micron in size.

Alternatively, as described in U.S. Pat. No. 5,863,319, the ink composition can be composed of an ester amide resin, a tackifying resin, and a colorant. The ester amide resin may be composed of polymerized fatty acids that have been combined with long chain monohydric alcohols and diamines. The ester amide resin may provide the ink with the appropriate thermal stability, flexibility, low melt viscosity, hardness and minimal shrinkage properties. The resin may be prepared by combining and heating a polymerized fatty acid, a monohydric alcohol and a diamine, while removing the water that is formed during the course of the reaction.

The ester amide resin may provide the ink with the appropriate thermal stability, flexibility, low melt viscosity, hardness and minimal shrinkage properties. The resin can be prepared by combining and heating a polymerized fatty acid, a monohydric alcohol and a diamine, while removing the water that is formed during the course of the reaction.

The polymerized fatty acid component includes dimer fatty acids, trimer fatty acids, and higher polymerization products. The fatty acids may have 12 to 20 carbon atoms. The fatty acids may be saturated or unsaturated, cyclic or acyclic. Examples include oleic acid, linoleic acid, linolenic acid, and tall oil fatty acid.

The monohydric long chain alcohols may have 22 to 90 carbon atoms. Examples of alcohols include 1-eicosanol, 1-docosanol and dotriacontanol, tetratriacontanol, pentatriacontanol, tetracontanol, and dopentaacontanol. The diamines may have 2 to 50 carbon atoms. Examples of diamines include 1,6-hexanediamine, ethylene diamine, 1,10-decanediamine, isophorone diamine, xylenediamine, poly(propyleneglycol)bis(2-aminopropylether), and other poly(alkyleneoxy)diamines, available from Texaco, Inc., under the trade name JEFFAMINE diamines.

The preferred ester amide resin is X37-4978-70, available from Union Camp of Princeton, N.J., under the designation X37-4978-70.

The ink should include enough of the ester amide resin so that the ink has thermal stability, flexibility at room temperature, low melt viscosity, hardness, and low shrinkage. The ink may include from about 10% to about 90%, preferably from about 60% to about 80%, of the ester amide resin by weight.

A tackifying resin may be included to enhance the adhesion of the ink to substrates such as plastic films; coated papers, plastics, metals and cardboard. The ink should include enough of the tackifying resin so that the ink, when applied to such a surface, does not flake, offset but not so much that the ink is tacky at room temperature. The ink may include from 10% to 15%, of the tackifying resin by weight.

Examples of tackifying resins include glycerol esters, pentaerythritol esters, hydrocarbons, rosin, rosin esters, modified rosin esters (e.g., hydrogenated, acid, or phenolic-modified rosin esters), cumarone-indene polymers, cyclic ketone polymers, styrene allyl alcohol polymers, polystyrenes, polyvinyl toluene/methylstyrene polymers, polyvinyl chloride, polyvinyl alcohol, ethylene/vinyl acetate, ethylene/acrylic acid, alkyl hydrocarbon polymers, aryl hydrocarbon polymers, alkyl aryl hydrocarbon polymers, terpene polymers, ethylene carbon monoxide copolymers, vinyl chloride/vinyl alcohol copolymers, polyvinyl butyral, polyketones, styrene/acrylic copolymers, polybutenes, polybutadienes, styrene-isoprene-styrene, styrene-butadiene-styrene, polyvinyl pyrrolidone, polyvinyl pyridine, vinyl pyrrolidone/vinyl acetate, polyurethanes, polyesters, polyamides, cellulose esters, cellulose ethers, polyols, styrene-acrylates, polypropylene, chlorinated polypropylene, chlorinated paraffin, gilsonite and other asphaltic materials, cyclic hydrocarbon polymer, halogenated polymers, acrylics, epoxides, novolacs, and other synthetic and natural resins. The most preferred tackifying resin is polyterpene, available from Goodyear under the trade name Wingtack 86.

The ink described in U.S. Pat. No. 5,863,319 should include a wax component which can decreases the tackiness of the ink at room temperature and helps provide the ink with the targeted melting point. Preferably the wax, or blend of waxes, has a melting point generally lower than the temperature at which the ink jet printer operates. The ink may contain enough wax that the ink is not tacky at room temperature, but not so much that the ink becomes brittle.

Examples of suitable waxes include stearic acid, lauric acid, linear polyethylene, behenic acid, stearone, carnauba wax, microcrystalline waxes, paraffin waxes, polyethylene wax, candelilla wax, montan wax, Fischer-Tropsch waxes, bisamide waxes, amide waxes, hydrogenated castor oil, synthetic ester waxes, oxidized polyethylene waxes, oleamides, stearamides, lauramides, erucamides, glycerol esters, chlorinated waxes, urethane modified waxes, and other synthetic and natural waxes. The most preferred wax is microcrystalline wax, available from Petrolite under the trade name BE SQUARE 175 AMBER.

The ink described in U.S. Pat. No. 5,863,319 may include a stabilizer which inhibits oxidation of the ink components. Sufficient stabilizer may be included to inhibit oxidation, but not so much should be included that the other properties of the ink are adversely affected. The ink may include less than about 2%, more preferably from about 0.3% to about 0.8%, of the stabilizer by weight. Suitable stabilizers may include antioxidants and heat stabilizers such as hindered phenols, organophosphites, phosphited phenols, phosphited bisphenols, bisphenols, and alkylated phenolics. A stabilizer which may be particularly useful is terakis[methylene (3,5-di-t-butyl-4-hydroxylhydrocinnamate)]methane, available from Ciba under the trade name IRGANOX 1010.

The ink described in U.S. Pat. No. 5,863,319 includes a sufficient quantity of dye so that the ink has adequate colour. The ink may comprise less than about 10%, such as from about 1% to about 2%, of the dye by weight. Examples of dyes include anthraquinone and perinone reds such as solvent red 172, solvent red 111, solvent red 222, solvent red 207, and solvent red 135; anthraquinone blues such as solvent blue 104, solvent violet 13; anthraquinone greens such as solvent green 3 and solvent green 5; xanthane, quinoline, quinophthalone, pyrazolone, methine, and anthraquinoid yellows such as solvent yellow 98, solvent yellow 33, disperse yellow 54, solvent yellow 93, disperse yellow 82, and solvent yellow 163. Dyes such as SANDOPLAST BLUE 2B (available from Clariant), Oracet yellow GHS (available from Ciba), and Polysolve Red 207 (available from Polysolve) may be used.

The ink optionally may include other conventional hot melt ink ingredients such as flexibilizers/plasticizers. Examples of flexibilizers/plasticizers include aromatic sulfonamides, phthalates, acetates, adipates, amides, azelates, epoxides, glutarates, laurates, oleates, sebacates, stearates, sulfonates, tallates, phosphates, benzoin ethers, and trimellitates.

The melting point or melt flow behaviour of a wax based ink compositions of U.S. Pat. Nos. 5,514,209 and 5,863,319 may be modified by the addition of waxes having a different melting point or melt flow behaviour including liquid waxes such as that obtained from Fluka (product Number 76233) CAS [8002-72-2]. The earlier suggested non-wax components can also affect the melting point or melt flow behaviour of the ink formulation.

The indicators of the present invention can be formed by a wide range of techniques. Preferably the indicators are formed by depositing the wax based inks such as those described in U.S. Pat. Nos. 5,514,209 or 5,863,319, as described above. The waxes can be applied to a substrate by inkjet printing. The substrate can be the surface of the product itself, its packaging or to a material which is subsequently affixed to the product or its packaging. Suitable substrates include paper, cardboard, acetate films, plastic substrates such as polypropylene, polyethylene terephthalate, acrylonitile-butachine-styrene resin, polycarbonate and acrylic resin substrates, metallic, ceramic, cloth or composite materials. The waxes can be applied to a substrate having an adhesive applied a side of the substrate for holding the substrate onto another material. The substrate may be an adhesive label.

The indicators of the present invention can be used in a wide range of applications. For example, the indicators can be used on the packaging of foodstuffs, chemicals that easily decompose, electronic components, hard drives, pharmaceuticals, complex fluids that phase separate upon heating, and many other temperature sensitive materials.

### EXAMPLE 1

### Wax Compositions

Wax compositions were prepared and tested by combining solid paraffin wax obtained from Walker Ceramics, Victoria Australia, (product number BA693); liquid paraffin wax obtained from Fluka, (product Number 76233) CAS [8002-72-2] and commercially available candle wax dyes.

The melting point of the solid paraffin wax was determined to be 58-62° C.

Mixtures of the waxes and dye were combined and mixed together at a temperature above the melting point of the highest component and allowed to solidify before the approximate melting point was determined. The dye comprised 0.5-1.0 wt % of the mixture. The approximate melting point was determined visually by using an oven and the results are set out in Table 1 below.

TABLE 1
Wax compositions and approximate melting points

| Wt % solid wax | Wt % liquid wax | Melting point ° C. | Notes |
|---|---|---|---|
| 15 | 85 | 31 | colourless |
| 20 | 80 | 39 | colourless |
| 25 | 75 | 40 | Blue dye |
| 33 | 67 | 44 | Green dye |
| 48 | 52 | 45 | Yellow dye |
| 50 | 50 | 48 | colourless |
| 80 | 20 | 53 | Red Dye |

The above results demonstrated that wax compositions having a desired melting point less than 58° C. could be created by simply combining appropriate amounts of the two paraffin waxes.

It is expected compositions with different melting points could be formed by combining waxes or other meltable materials.

### EXAMPLE 2

### Dye Combinations

Assorted candle dyes were used to colour the paraffin wax. The colours used were red, yellow and blue. It was observed that the melting point of a wax composition containing 0.5-1.0 wt % candle dye is ˜1-3° C., higher than the wax composition without the dye. It is believed that this merely reflects the higher melting point of the wax base of the dye materials.

Mixtures of the dyes were added to the wax composition and it was observed that the mixture of coloured dyes could be used to provide a wide range of different colours. Red dye and yellow dye provided an orange coloured wax composition. Likewise, blue dye and red dye gave a purple coloured wax composition and blue and yellow gave green coloured wax composition.

### EXAMPLE 3

### Visual Thermal History Indicator

A series of experiments were conducted to investigate the behaviour of the waxes when heated above their melting temperature.

With reference to FIG. 1, a strip of yellow coloured wax (shown in hash) and blue wax (shown in solid black) were placed in a glass Petrie dish of diameter 60 mm to depth of approximately 1 mm. The side edges of the two wax stripes were contact with each other. A molten colourless wax with a melting point higher than the two coloured waxes was added into the dish and surrounded coloured strips of wax and was allowed to cool and solidify before testing.

The dish and waxes were heated for one hour in an oven at a temperature above the melting point of the coloured waxes but below the melting point of the colourless wax and then allowed to cool.

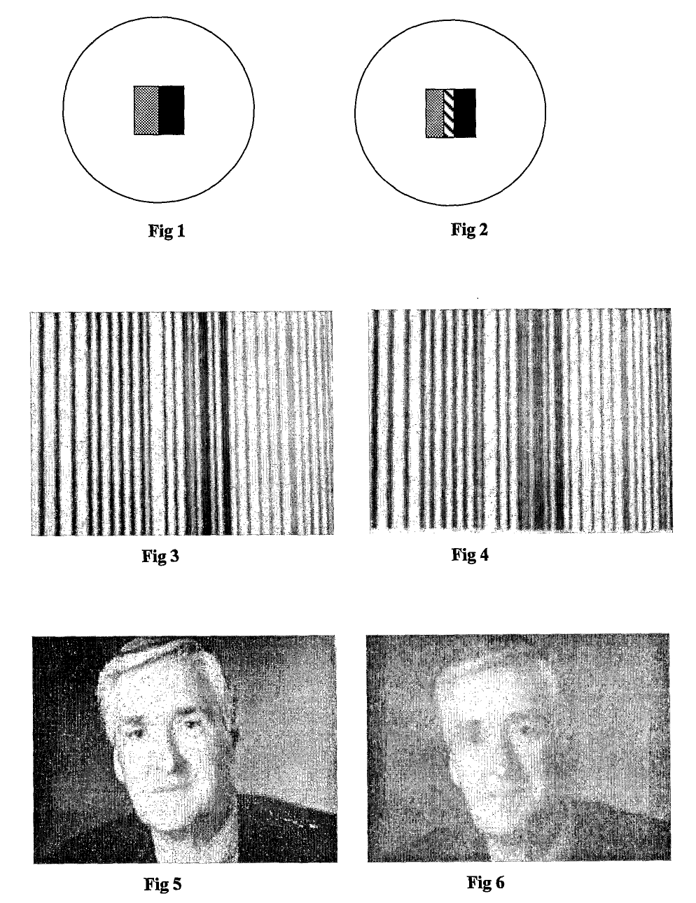

The result of the heating is shown in FIG. 2. It was found that the original coloured waxes had mixed in a region near the area of contact of the two strips. This central region (shown with diagonal strips) had a noticeable different colour, namely green.

The test was repeated using wax strips of different colours and different melting points. It was found that the colours would only mix when the temperature exceeded the melting point of both of the coloured wax strips.

### EXAMPLE 4

### Printed Visual Thermal History Indicator (on Paper Substrate)

Two printers were employed in the production of the visual thermal history indicators. Each coloured ink used within the printer had a single activation temperature. The inks were commercially available “colorstix” wax inks obtained from Fuji Xerox. The printers used were a Xerox Tektronix 850 and Tektronix Phaser 8200DP. The results were substantially the same.

Photographs of the printed indicators (before, during and after activation) were taken using a Canon Powershot S45 Digital camera (4 Megapixels) mounted on a tripod approximately 30 cm above the sample. The camera zoom was set to 6.7× or 8.2×. Flash was not employed. The images were taken in colour, transferred to a PC and converted to grayscale images.

FIGS. 3 and 4 show a barcode printed on conventional photocopy paper using the Tektronix 850 printer. The indicator shown in FIG. 3 was not exposed to a temperature above its activation temperature and the barcode lines were clear and sufficiently distinct to enable the code to be scanned.

The same indicator was subsequently heated to a temperature above its activation temperature and then allowed to cool. Activation of the indicator was achieved by placing the paper on a hotplate (setting high) for 120 secs. The result is shown in FIG. 4. The barcode lines were blurred and insufficiently distinct to enable the code to be machine scanned.

FIGS. 5 and 6 are greyscale images of a colour visual thermal history indicator in the form of a photograph image. The photograph was produced using the Phaser 8200 printer on standard office copy paper and was approximately 5 cm×4 cm in size. The photograph depicted in FIG. 5 has not been heated. In contrast, FIG. 6 shows the same photograph after activation by placing the paper on a hotplate (setting medium) for 120 secs.

### EXAMPLE 5

### Printed Visual Thermal History Indicator (on Mylar Transparency Sheets)

Similar to that described in Example 4 above, images were printed using Xerox Tektronix 850 or Tektronix Phaser 8200DP printer but onto Mylar transparency sheets instead of paper.

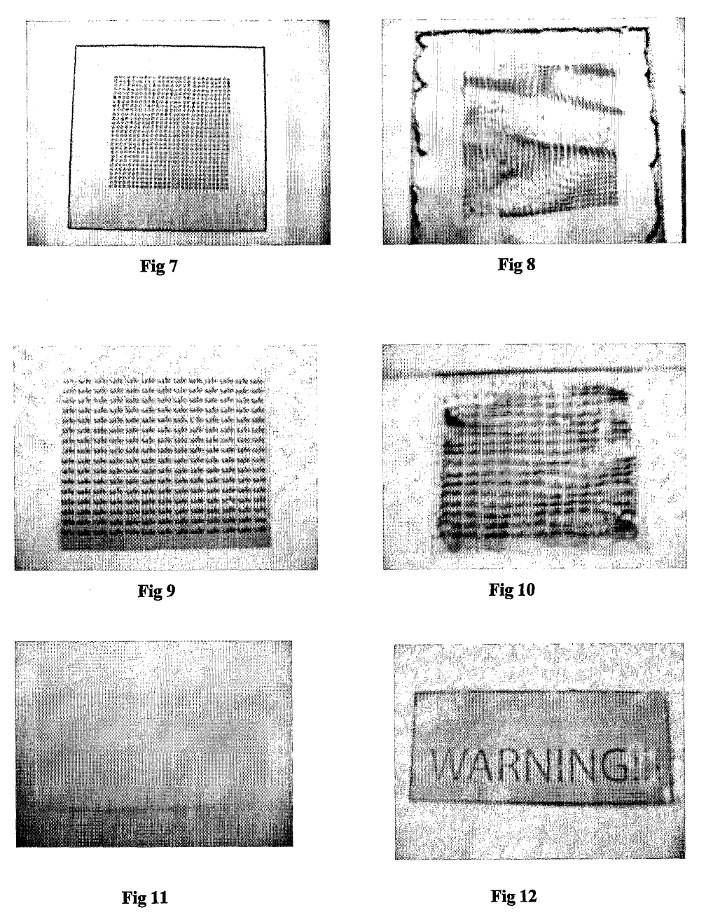

The results of printing a dot pattern are shown in FIGS. 7 and 8 (before and after activation by exposure to hotplate). With regard to FIG. 8 the sheet is not crumpled, it only appears that way and reflects the uneven spread of heat to the sample.

FIGS. 9 and 10 show the results of printing “safe” before and after activation by exposure to the hotplate.

### EXAMPLE 6

### Concealed Indicators (on Paper Sheets)

The presence of an indicator can be concealed by depositing the indicator on the rear face of an absorbent support material such as paper. The paper shown in FIG. 11 has the word WARNING printed in mirror image on its reverse side. FIG. 12 shows the same side of the paper after activation. The wax and dye has flowed into the paper which enables the message to be seen.

Since modifications within the spirit and scope of the invention may be readily effected by persons skilled in the art, it is to be understood that the invention is not limited to the particular embodiment described, by way of example, hereinabove.

1.-22. (canceled)

23. A visual thermal history indicator comprising a pattern produced from at least two waxes wherein one wax has a melting point that differs from the other wax, or where the waxes have the same melting point but different melt flow behavior, and wherein the pattern is adapted so that when the lower melting point wax melts or the wax with greater melt flow behavior flows, the visual appearance of the pattern changes, and wherein when the second and subsequent higher melting waxes melt, or when the lower melt flow behavior waxes flow, the visual appearance of the pattern changes as each wax melts or flows.

24. The visual thermal history indicator of claim 23 wherein at least two waxes or compositions containing each of the waxes and producing the pattern have different visual appearances.

25. The visual thermal history indicator of claim 24 wherein the at least two waxes or compositions have different colors.

26. The visual thermal history indicator of claim 23 wherein the waxes have different melt flow characteristics such that the combination of waxes yields a mixture with different optical properties.

27. The visual thermal history indicator of claim 26 wherein the different optical properties is birefringence or loss of birefringence.

28. The visual thermal history indicator of claim 23 wherein at least two waxes having different melting points or melt flow behaviors are located within a common layer.

29. The visual thermal history indicator of claim 28 wherein at least a portion of one wax is adjacent to or abuts a portion of at least a portion of the other wax.

30. The visual thermal history indicator of claim 23 wherein the pattern comprises an arrangement of the at least two waxes on a common substrate.

31. The visual thermal history indicator of claim 30 wherein the common substrate is paper, polymeric, cloth, metal, ceramic or a composite material.

32. The visual thermal history indicator of claim 23 wherein the waxes are deposited by printing process.

33. The visual thermal history indicator of claim 23 wherein the waxes are deposited by non-impact printing.

34. The visual thermal history indicator of claim 23 wherein the waxes are deposited to a substrate in a single pass of a printing head.

35. The visual thermal history indicator of claim 23 wherein the pattern is deposited on one side of a substrate and is capable of providing a visual indication on the other side of the substrate if the substrate is heated to an activation temperature whereby a wax forming part of the pattern melts or flows.

36. The visual thermal history indicator of claim 23 wherein the pattern is applied to a substrate which has an adhesive backing.

37. The visual thermal history indicator of claim 23 wherein the pattern is a photograph, graphic image, symbol, text, geometrical image or barcode.

38. A method of monitoring the thermal history of an object by attaching a visual thermal history indicator of claim 23 to the object and subsequently monitoring for changes in the pattern of the indicator.

39. The method of claim 38 wherein the melting points of the at least two waxes or compositions containing the waxes forming the pattern correlates with temperatures for which it is desirable to determine whether the indicator has been allowed to heat to those temperatures.

40. The method of claim 38 wherein a machine is used to identify changes in the pattern.

41. The method of claim 38 wherein changes are accessed by accessing the degree of mixing of waxes in the pattern.

42. A method of producing a visual thermal history indicator of claim 23 by printing a pattern containing at least two wax based inks, the inks having different melting points and corresponding to temperatures for which it is desired to provide an indication as to whether the indicator has been exposed to those temperatures.
